(19) United States
(12) Patent Application Publication
(10) Pub. No.: US 2018/0268723 A1
(43) Pub. Date: Sep. 20, 2018

(54) SYSTEM, METHOD, AND PROGRAM FOR CONTROLLING TRAFFIC OF UNINHABITED VEHICLE

(71) Applicant: OPTiM Corporation, Saga-shi (JP)

(72) Inventor: Shunji SUGAYA, Tokyo (JP)

(21) Appl. No.: 15/533,702

(22) PCT Filed: Jul. 27, 2016
(86) PCT No.: PCT/JP2016/072021

§ 371 Date: Jun. 7, 2017

(51) Int. Cl. G08G 5/00

(52) U.S. Cl. CPC G08G 5/0069; G08G 5/0039; G08G 5/006; G08G 5/0091; G08G 5/0082

(57) ABSTRACT

The present invention provides a system, a method, and a program for controlling traffic of an uninhabited vehicle, which are benefit when applied to the control of uninhabited vehicles, specifically uninhabited airborne vehicles. The system for controlling traffic of an uninhabited vehicle 100 includes a location information receiving unit 111 that receives location information about the locations from the uninhabited vehicles D1 to D3 and the like that are in action (flight) and a vehicle information receiving unit 112 that receives vehicle information about the identifications of the vehicles from the uninhabited vehicles D1 to D3 and the like that are in action. The system for controlling traffic of an uninhabited vehicle 100 also includes a plan check unit 120 that checks whether or not the received location information and the received vehicle information are the same as those in the permitted plan and a plan instruction unit 130 that instructs the uninhabited vehicle to act in accordance with the plan if the check result is false.

### TECHNICAL FIELD

The present invention relates to a system, a method, and a program for controlling traffic of an uninhabited vehicle, which are benefit when applied to the control of uninhabited vehicles, specifically uninhabited airborne vehicles.

### BACKGROUND ART

To control the traffic flow of mobile objects such as aircrafts, a flight plan has been determined for each aircraft. The flight of the aircraft has been operated in accordance with this determined flight plan. The control towers that control the traffic flow of aircrafts always know the location, etc., of the aircraft under operation from various sensors. Air traffic controllers in the control towers instruct a pilot who is flying the aircraft that is required to correct its once determined flight plan or the aircraft that is deviating from the flight plan to correct the flight plan, which enables control of aircrafts.

On the other hand, recently, for example, the development of uninhabited vehicles, specifically, uninhabited airborne vehicles as described in Patent Document 1 as mobile objects without passengers that are remotely or autonomously controlled has been advanced. These uninhabited vehicles enable significant size reduction because of no need for passenger space and thus have a high degree of freedom for their travel ranges. To prevent this travel range from indefinitely expanding, the no-fly zones are previously imposed, or the in-advance application is required for their flight plans

### CITATION LIST

### Patent Literature

Patent Document 1: JP H11-02500 A

### SUMMARY OF INVENTION

However, since uninhabited vehicles are smaller than inhabited vehicles, their locations are hardly accurately detected by conventional sensors for aircrafts.

Furthermore, no pilots are on board an uninhabited vehicle. Thus, the control towers hardly prompt the uninhabited vehicle to change its flight plan even if the uninhabited vehicle is violating no-fly zones or deviates from the applied flight plan. In view of the above-mentioned problems, an objective of the present invention is to provide a system, a method, and a program for controlling traffic of an uninhabited vehicle that are capable to appropriately manage the activity area of the uninhabited vehicle.

The first aspect of the present invention provides a system for controlling traffic of an uninhabited vehicle that is in action, including:

a location information receiving unit that receives location information from the uninhabited vehicle that is in action;

a vehicle information receiving unit that receives vehicle information from the uninhabited vehicle that is in action;

a check unit that checks whether or not the received location information and the received vehicle information are the same as those in the permitted plan; and

a plan instruction unit that instructs the uninhabited vehicle to act in accordance with the plan if the check result is false.

According to the first aspect of the present invention, a system for controlling traffic of an uninhabited vehicle that is in action receives location information from the uninhabited vehicle that is in action; receives vehicle information from the uninhabited vehicle that is in action; checks whether or not the received location information and the received vehicle information are the same as those in the previously permitted plan, and instructs the uninhabited vehicle to act in accordance with the plan if the check result is false.

The second aspect of the present invention provides the system further including a user warning unit that warns a user of the uninhabited vehicle if the received vehicle information does not exist in the plan.

According to the second aspect of the present invention, the system warns a user of the uninhabited vehicle if the received vehicle information does not exist in the plan.

The third aspect of the present invention provides the system further including an uninhabited vehicle control unit that forces the uninhabited vehicle to stop if the received vehicle information does not exist in the plan.

According to the third aspect of the present invention, the system forces the uninhabited vehicle to stop if the received vehicle information does not exist in the plan.

The fourth aspect of the present invention provide the system further including an uninhabited vehicle shooting unit that shoots the uninhabited vehicle if the received vehicle information does not exist in the plan.

According to the fourth aspect of the present invention, the system shoots the uninhabited vehicle if the received vehicle information does not exist in the plan.

The fifth aspect of the present invention provides the system further including: an in-advance application receiving unit that receives in-advance application of the plan from a user of the uninhabited vehicle; and a permission transmission unit that transmits permission for the received plan to the user.

According to the fifth aspect of the present invention, the system receives in-advance application of the plan from a user of the uninhabited vehicle; and transmits permission for the received plan to the user.

The sixth aspect of the present invention provides the system further including a distance instruction unit that instructs the uninhabited vehicle to keep a predetermined distance from a different uninhabited vehicle when the distance between the uninhabited vehicle and the different uninhabited vehicle fulfills a predetermined condition.

According to the sixth aspect of the present invention, the system instructs the uninhabited vehicle to keep a predetermined distance from a different uninhabited vehicle when the distance between the uninhabited vehicle and the different uninhabited vehicle fulfills a predetermined condition.

The seventh aspect of the present invention provides the system further including: a weather information acquisition unit that acquires weather information; a change unit that changes the plan to a latest plan based on the acquired weather information; and a latest plan transmission unit that transmits the latest plan to the uninhabited vehicle.

According to the seventh aspect of the present invention, the system further acquires weather information; changes the plan to a latest plan based on the acquired weather information; and transmits the latest plan to the uninhabited vehicle.

The eighth aspect of the present invention provides the system in which the location information receiving unit that receives location information from the uninhabited vehicle that is in action at a predetermined interval.

According to the eighth aspect of the present invention, the system receives location information from the uninhabited vehicle that is in action at a predetermined interval.

The ninth aspect of the present invention provides the system in which the vehicle information receiving unit that receives the vehicle information from the uninhabited vehicle that is in action at a predetermined interval.

According to the ninth aspect of the present invention, the system receives vehicle information from the uninhabited vehicle that is in action at a predetermined interval.

The tenth aspect of the present invention provides the system further including: an image acquisition unit that acquires an image from a network camera; and a warning unit that issues a warning if the uninhabited vehicle that appears in the acquired image is not previously permitted.

According to the tenth aspect of the present invention, the system acquires an image from a network camera; and issues a warning if the uninhabited vehicle that appears in the acquired image is not previously permitted.

The eleventh aspect of the present invention provides a method for controlling traffic of an uninhabited vehicle that is in action, including the steps of:

receiving location information from the uninhabited vehicle that is in action;

receiving vehicle information from the uninhabited vehicle that is in action;

checking whether or not the received location information and the received vehicle information are the same as those in the previously permitted plan; and

instructing the uninhabited vehicle to act in accordance with the plan if the check result is false.

According to the eleventh aspect of the present invention, a method for controlling traffic of an uninhabited vehicle that is in action receives location information from the uninhabited vehicle that is in action; receives vehicle information from the uninhabited vehicle that is in action; checks whether or not the received location information and the received vehicle information are the same as those in the previously permitted plan, and instructs the uninhabited vehicle to act in accordance with the plan if the check result is false.

The twelfth aspect of the present invention provides a computer program product for use in a system for controlling traffic of an uninhabited vehicle that is in action, including a non-transitory computer usable medium having a set of instructions physically embodied therein, the set of instructions including computer readable program code, which when executed by the system causes the information processing unit to:

receive location information from the uninhabited vehicle that is in action;

receive vehicle information from the uninhabited vehicle that is in action;

check whether or not the received location information and the received vehicle information are the same as those in the previously permitted plan; and

instruct the uninhabited vehicle to act in accordance with the plan if the check result is false.

According to the twelfth aspect of the present invention, a computer program product for use in a system for controlling traffic of an uninhabited vehicle that is in action receives location information from the uninhabited vehicle that is in action; receives vehicle information from the uninhabited vehicle that is in action; checks whether or not the received location information and the received vehicle information are the same as those in the previously permitted plan, and instructs the uninhabited vehicle to act in accordance with the plan if the check result is false.

The present invention can provide a system, a method, and a program for controlling traffic of an uninhabited vehicle, which are benefit when applied to the control of uninhabited vehicles, specifically uninhabited airborne vehicles.

### BRIEF DESCRIPTION OF DRAWINGS

FIG. 1 shows a block diagram illustrating the skeleton framework of a system, a method, and a program for controlling traffic of an uninhabited vehicle according to a first embodiment of the present invention.

FIG. 2 shows one example of the permission status of flight plans.

FIG. 3 shows one example of a permitted flight plan.

FIG. 4 shows one example of flight plan control for an uninhabited vehicle.

FIG. 5 shows a block diagram illustrating the skeleton framework of a system, a method, and a program for controlling traffic of an uninhabited vehicle according to a second embodiment of the present invention.

FIG. 6 shows one example of the distance intervals among uninhabited vehicles seen from the sky.

FIG. 7 shows one example of the distance intervals among uninhabited vehicles seen in a horizontal direction.

FIG. 8 shows one example of changing a flight plan according to a meteorological event.

FIG. 9 shows one example of intervals of transmitting and receiving the location information and the vehicle information of an uninhabited vehicle.

FIG. 10 shows one example of flight control based on the image of an uninhabited vehicle.

FIG. 11 shows one example of flight control for an uninhabited vehicle in a system, a method, and a program for controlling traffic of an uninhabited vehicle.

### DESCRIPTION OF EMBODIMENTS

### First Embodiment

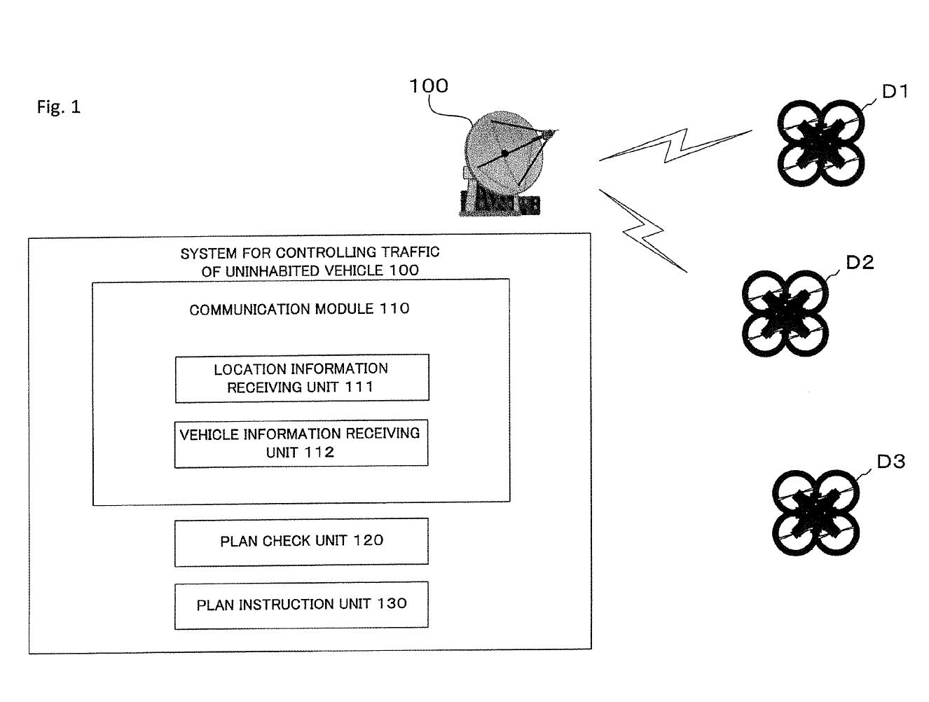

A first embodiment of the present invention will be described below with reference to FIGS. 1 to 4. However, this is illustrative only, and the technological scope of the present invention is not limited thereto.

### Configuration of System for Controlling Traffic of Uninhabited Vehicle

As shown in FIG. 1, the system for controlling traffic of an uninhabited vehicle 100 according to this embodiment includes a communication module 110 that communicates with the uninhabited airborne vehicles D1 to D3 and the like. The communication module 110 includes a location information receiving unit 111 that receives location information about the locations from the uninhabited vehicles D1 to D3 and the like that are in action (flight) and a vehicle information receiving unit 112 that receives vehicle information about the identifications of the vehicles from the uninhabited vehicles D1 to D3 and the like that are in action. The system for controlling traffic of an uninhabited vehicle 100 also includes a plan check unit 120 that checks whether or not the received location information and the received vehicle information are the same as those in the permitted plan and a plan instruction unit 130 that instructs the uninhabited vehicle to act in accordance with the plan if the check result is false.

For example, the system for controlling traffic of an uninhabited vehicle 100 includes an airport control tower; a communication facility over which a local government exercises jurisdiction; a server system that is capable to communicate with an uninhabited vehicle; and an information terminal including a central processing unit (hereinafter referred to as “CPU”), a random-access memory (hereinafter referred to as “RAM”), and a read-only semiconductor memory (hereinafter referred to as “ROM”). The location information receiving unit 111, the vehicle information receiving unit 112, the plan check unit 120, and the plan instruction unit 130 include a program installed in CPU, ROM, RAM, and the like; or a control circuit.

The communication module 110 communicates with each uninhabited vehicles D1 to D3 and the like directly or indirectly through a server. The communication module 110 may communicate with the information terminal that the user of each of the uninhabited vehicles D1 to D3 owns. Any communication methods may be available for the communication module 110, including Wireless PAN such as Bluetooth® and ZigBee®, Wireless LAN such as Wi-Fi®, and Wireless MAN.

The location information receiving unit 111 receives location information that indicates the latitude, the longitude, and the flight altitude of each of the uninhabited vehicles D1 to D3. The latitude, the longitude, and the flight altitude are transmitted from each of the uninhabited vehicles D1 to D3 and the information terminals and the like that the users of the uninhabited vehicles own. The location information receiving unit 111 outputs the received location information to the plan check unit 120 each time it receives the location information.

The vehicle information receiving unit 112 receives vehicle information that indicates the identification information on each of the uninhabited vehicles D1 to D3. The vehicle information is transmitted from each of the uninhabited vehicles D1 to D3, the information terminals that the users of the uninhabited vehicles own, and the like. The vehicle information is identification information to identify each of the uninhabited vehicles D1 to D3. The vehicle information receiving unit 112 outputs the received vehicle information to the plan check unit 120 each time it receives the vehicle information.

When receiving the location information and the vehicle information, the plan check unit 120 checks whether or not the location information and the vehicle information are the same as those in the previously permitted flight plan. The plan check unit 120 outputs the check result to the plan instruction unit 130.

If the check result input from the plan check unit 120 is “false,” the plan instruction unit 130 generates instruction information to instruct the uninhabited vehicle or its user (information terminal) to act in accordance with the plan. After generating instruction information, the plan instruction unit 130 transmits this generated instruction information to the intended uninhabited vehicle or its user (information terminal). Accordingly, the uninhabited vehicle that has received instruction information corrects the flight plan based on the instruction information. The information terminal that has received instruction information forwards this instruction information to the uninhabited vehicle or corrects the flight plan to be transmitted to the uninhabited vehicle, so as to correct the flight plan of the uninhabited vehicle to the instructed plan.

### Overview of Vehicle Information and Flight Plan

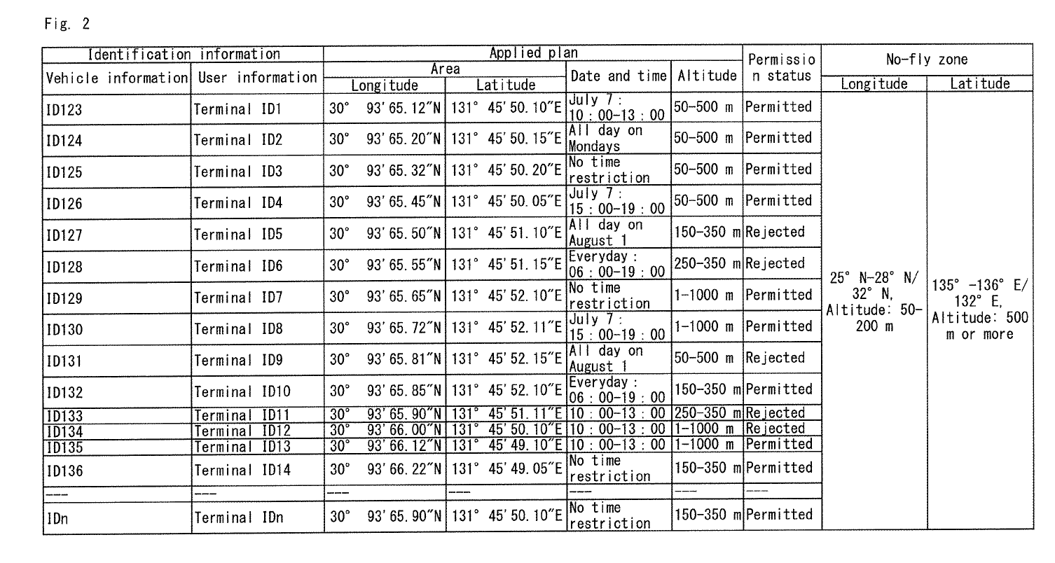

As illustrated in FIG. 2, the plan check unit 120 according to this embodiment checks the location information and the vehicle information received from an uninhabited vehicle and the permitted flight plan based on the operation map in which information on the identification information, the application plan, the permission status, and the no-fly zone are reflected. This operation map is appropriately updated every predetermined time period or each time it is changed. In this embodiment, for example, the vehicle information on uninhabited vehicles is set to ID123 to IDn as identification information to identify the types and the users of the uninhabited vehicles. As the identification information on the users of uninhabited vehicles, information on each of the information terminals ID1-IDn that are owned by the users and communicative with the uninhabited vehicles is associated and stored with the ID of each uninhabited vehicle. This enables the plan instruction unit 130 to notify the above-mentioned instruction information to the users of uninhabited vehicles.

Furthermore, as shown in FIG. 2, the application plan that indicates the applied flight plan in latitudes and longitudes for each uninhabited vehicle and the permission status are registered in the operation map. In addition, the latitudes and the longitudes of no-fly zones where uninhabited vehicles are prohibited from flying without exception are registered in the operation map. The no-fly zones are imposed over electric power plants, communication facilities, urban areas, skyscrapers, schools, residential areas, etc. The application plan includes a series of latitudes and longitudes of a predetermined flight area and a series of latitudes, longitudes, flight altitudes, and times and dates of a flight course. Since the permission status for each application plan is associated with identification information on each application plan, the plan check unit 120 can compare the location information and the vehicle information received from an uninhabited vehicle with those in the operation map and check whether or not the uninhabited vehicle that is in action is flying in accordance with the permitted flight plan and is flying without the no-fly zones.

The plan check unit 120 according to this embodiment, checks whether or not an uninhabited vehicle that is in action is flying in accordance with the flight plan and is flying without the no-fly zones but may check either of these. In this case, the above-mentioned instruction information is generated if an uninhabited vehicle that is in action is not flying in accordance with the flight plan or is flying within a no-fly zone.

### Overview of Controlling Traffic of Uninhabited Vehicle

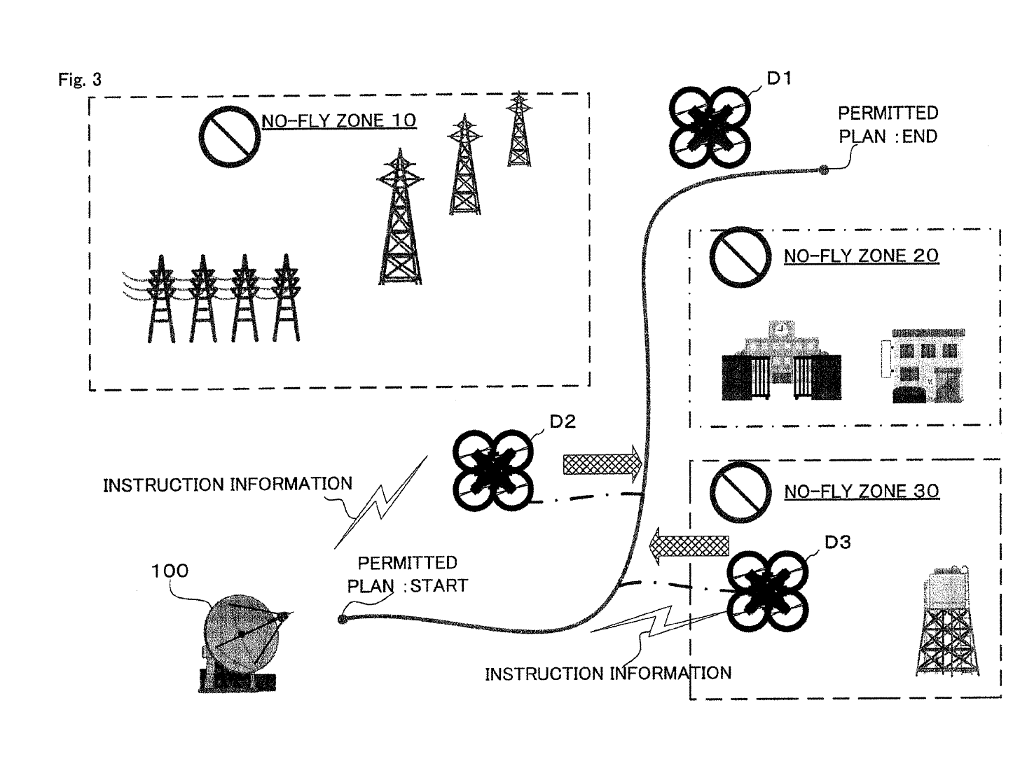

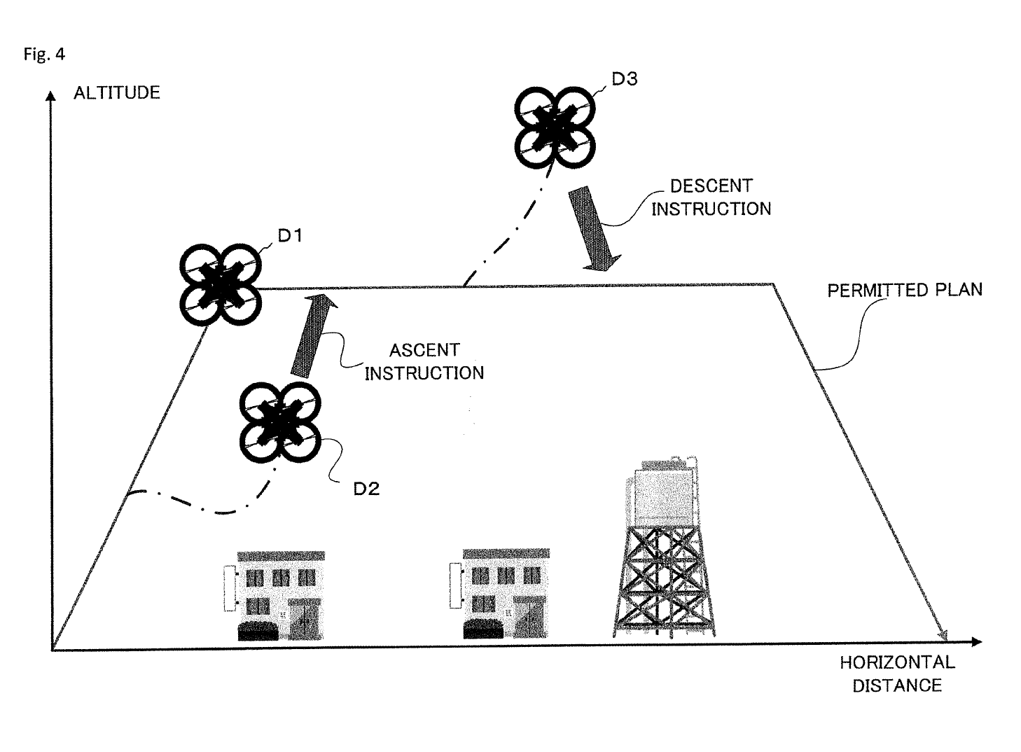

FIGS. 3 and 4 show one example of traffic control of uninhabited vehicles by the system for controlling traffic of an uninhabited vehicle 100.

As shown in FIG. 3, for example, as a permitted plan that is a flight plan previously applied from and permitted for the first to the third uninhabited vehicles D1 to D3, the flight route represented by a solid line is predetermined. Furthermore, the no-fly zones 10, 20, and 30 where the uninhabited vehicles D1 to D3 and the like are prohibited from flying without exception are imposed. In the example of FIG. 3, the flight in accordance with the previously permitted plan as the flight route represented by a solid line that is excluded from the no-fly zones 10, 20, and 30 is permitted for the first to the third uninhabited vehicles D1 to D3

In this example, the first uninhabited vehicle D1 is flying along the permitted route specified in the permitted plan on the date and time that are also permitted. Thus, the system for controlling traffic of an uninhabited vehicle 100 does not transmit instruction information to the first uninhabited vehicle D1 because it does not need the first uninhabited vehicle D1 that is in action to change the flight route. On the other hand, the second uninhabited vehicle D2 is deviating from the permitted plan, and thus the system for controlling traffic of an uninhabited vehicle 100 transmits instruction information to guide the second uninhabited vehicle D2 to the permitted plan. Furthermore, the third uninhabited vehicle D3 is deviating from the permitted plan and penetrates the no-fly zone 30, and thus the system for controlling traffic of an uninhabited vehicle 100 transmits instruction information to exit the no-fly zone 30 and guide the third uninhabited vehicle D3 to the permitted plan. As a result, the uninhabited vehicles D2 and D3 are prompted to fly in accordance with the permitted plan. Since the third uninhabited vehicle D3 is deviating from the permitted plan and is flying in a no-fly zone, the system for controlling traffic of an uninhabited vehicle 100 can uses a higher-priority important communication to transmit instruction information to the uninhabited vehicle D3 and the user's information terminal.

As shown in FIG. 4, if a restriction concerning the altitude is set in a flight plan, a flight altitude is specified from the start to the end. For example, if the second uninhabited vehicle D2 is flying lower than the altitude range set in the permitted flight plan along the flight route, the system for controlling traffic of an uninhabited vehicle 100 transmits instruction information to the uninhabited vehicle D2 to increase its flight altitude to the set altitude range. On the other hand, if the third uninhabited vehicle D3 is flying higher than the altitude range set in the permitted flight plan along the flight route, the system for controlling traffic of an uninhabited vehicle 100 transmits instruction information to the uninhabited vehicle D3 to reduce its flight altitude to the set altitude range. As a result, the flight altitudes of the uninhabited vehicles D1 to D3 are maintained within the range in their respective flight plans.

### Second Embodiment

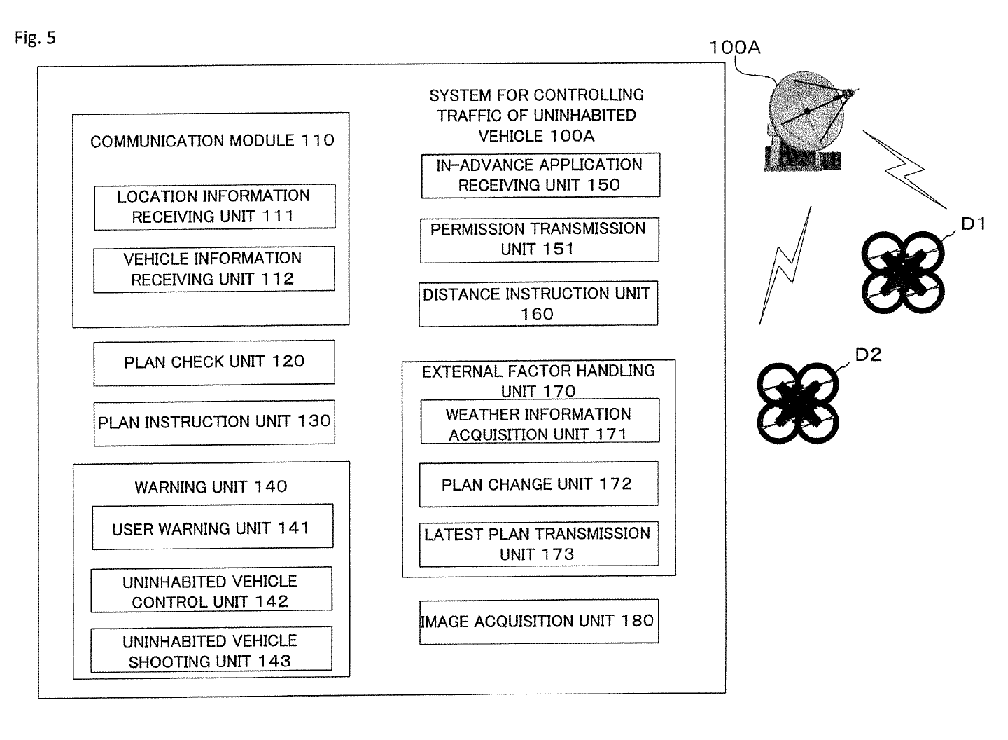

A second embodiment of the present invention will be described below with reference to FIGS. 5 to 11. However, this is illustrative only, and the technological scope of the present invention is not limited thereto. In this embodiment, the same signs are provided to elements in common with those of the first embodiment. The differences from the first embodiment will be mainly described.

### Configuration of System for Controlling Traffic of Uninhabited Vehicle

As shown in FIG. 5, the system for controlling traffic of an uninhabited vehicle 100A according to this embodiment further includes an warning unit 140 that warns an uninhabited vehicle, the applied flight plan of which is unapproved, an uninhabited vehicle that has not applied the flight application, an uninhabited vehicle that is deviating from the permitted flight plan, and an uninhabited vehicle that is flying in the no-fly zone, and the user thereof. The warning unit 140 includes a user warning unit 141 that transmits warning information to the information terminal that the users of the uninhabited vehicles own for warning. The warning unit 140 also includes an uninhabited vehicle control unit 142 that forces to stop and guide the uninhabited vehicles for warning. The warning unit 140 also includes an uninhabited vehicle shooting unit 143 that fires a warning shot or a shot at the uninhabited vehicles for warning.

The user warning unit 141, the uninhabited vehicle control unit 142, and the uninhabited vehicle shooting unit 143 warn an uninhabited vehicle, the applied flight plan of which is unapproved, an uninhabited vehicle that has not applied the flight application, an uninhabited vehicle that is deviating from the permitted flight plan, and an uninhabited vehicle that is flying in the no-fly zone. In other words, the user warning unit 141, the uninhabited vehicle control unit 142, and the uninhabited vehicle shooting unit 143 transmits warning information, forces to stop or guide the uninhabited vehicle, and fires a warning shot, respectively. Furthermore, for example, the user warning unit 141, the uninhabited vehicle control unit 142, and the uninhabited vehicle shooting unit 143 may warn an uninhabited vehicle on the condition that the uninhabited vehicle does not follow the instruction information transmitted from the plan instruction unit 130 at predetermined times or when a predetermined time has passed since instruction information was transmitted. Furthermore, the plan instruction unit 130, the user warning unit 141, the uninhabited vehicle control unit 142, and the uninhabited vehicle shooting unit 143 may warn an uninhabited vehicle in a step-by-step manner. For example, the plan instruction unit 130 transmits instruction information, the user warning unit 141 warns the user, the uninhabited vehicle control unit 142 forces to stop or guide the uninhabited vehicles, and the uninhabited vehicle shooting unit 143 fires a warning shot or a shot, in time series. Furthermore, at least one of the user warning unit 141, the uninhabited vehicle control unit 142, and the uninhabited vehicle shooting unit 143 may warn only an uninhabited vehicle that penetrates the no-fly zone.

The system for controlling traffic of an uninhabited vehicle 100A also includes an in-advance application receiving unit 150 that receives in-advance application for the flight plan from the user of an uninhabited vehicle and the user's information terminal and a permission transmission unit 151 that transmits permission for the received plan to the uninhabited vehicle and the user's information terminal.

For example, the in-advance application receiving unit 150 receives a transmitted flight plan selected and transmitted through the execution of an application program installed in the uninhabited vehicle or the information terminal that the user owns. Then, for example, the in-advance application receiving unit 150 confirms that the applied flight plan is not contained in the no-fly zones and that neither the courses nor the dates and times in the flight plans of other uninhabited vehicles overlap with each other through the operation map shown in FIG. 2 and permits the applied flight plan. The in-advance application receiving unit 150 outputs the result of permission or rejection to the permission transmission unit 151. Furthermore, the in-advance application receiving unit 150 adds the permit flight plan to the operation map shown in FIG. 2 to update the operation map as needed. The in-advance application receiving unit 150 according to this embodiment requests the uninhabited vehicle with a permitted flight plan to submit at least one of “image” that shows the appearance of the uninhabited vehicle and “vehicle information” such as the ID of the uninhabited vehicle. When at least one of the image and the vehicle information of the uninhabited vehicle is submitted, the in-advance application receiving unit 150 registers the image or the vehicle information together with the permitted plan for the operation map that the plan check unit 120 manages. Accordingly, the vehicle information, the image, and the permitted plan are associated with each other at any time. If it is capable to know the size of the uninhabited vehicle through the vehicle information, the in-advance application receiving unit 150 may permit the application according to the size: small (the permission area is reasonably limited), medium (the permission area is moderately limited), and large (the permission area is tightly limited for passenger planes usually).

When the result of permission or rejection is input from the in-advance application receiving unit 150, the permission transmission unit 151 transmits information that indicates this result to the uninhabited vehicle or the information terminal that applied the flight plan. For example, the information terminal shows the result of permission or rejection to the user of the uninhabited vehicle with sound or images.

The system for controlling traffic of an uninhabited vehicle 100A also includes a distance instruction unit 160 that instructs any one or both of an uninhabited vehicle and a different uninhabited vehicle to keep a predetermined distance from each other when the distance between them fulfills a predetermined condition. If the instructed uninhabited vehicle does not keep a predetermined distance from a different uninhabited vehicle after a predetermined time period passed or after a predetermined instruction, the distance instruction unit 160 may request the above-mentioned warning unit 140 to warn the uninhabited vehicle (by warning the user, forcing to control the uninhabited vehicle, or firing a warning shot).

The system for controlling traffic of an uninhabited vehicle 100A also includes an external factor handling unit 170 that handles dynamically changed external factors by changing the flight plan according to external factors affecting an uninhabited vehicle. The external factors affect the flight of the uninhabited vehicle, including weather, construction in the flight area, the unscheduled flights of other passenger aircrafts, and the communication situation. As the external factors, the dynamically changing ones are set.

The external factor handling unit 170 also includes a weather information acquisition unit 171 that acquires weather information that is information on the weather as an external factor from, for example, the weather information center; and a plan change unit 172 that changes the flight plan of the uninhabited vehicle to the latest plan based on the acquired weather information. The external factor handling unit 170 also includes a latest plan transmission unit 173 that transmits the latest plan changed and updated by the plan change unit 172 to the uninhabited vehicle and the user's information terminal.

The system for controlling traffic of an uninhabited vehicle 100A also includes an image acquisition unit 180 that acquires images from a camera that is a network camera with a server function. The image acquisition unit 180 acquires the image of the uninhabited vehicle that is imaged by the network camera and outputs the acquired image to the plan check unit 120, as needed

Instruction for Distance

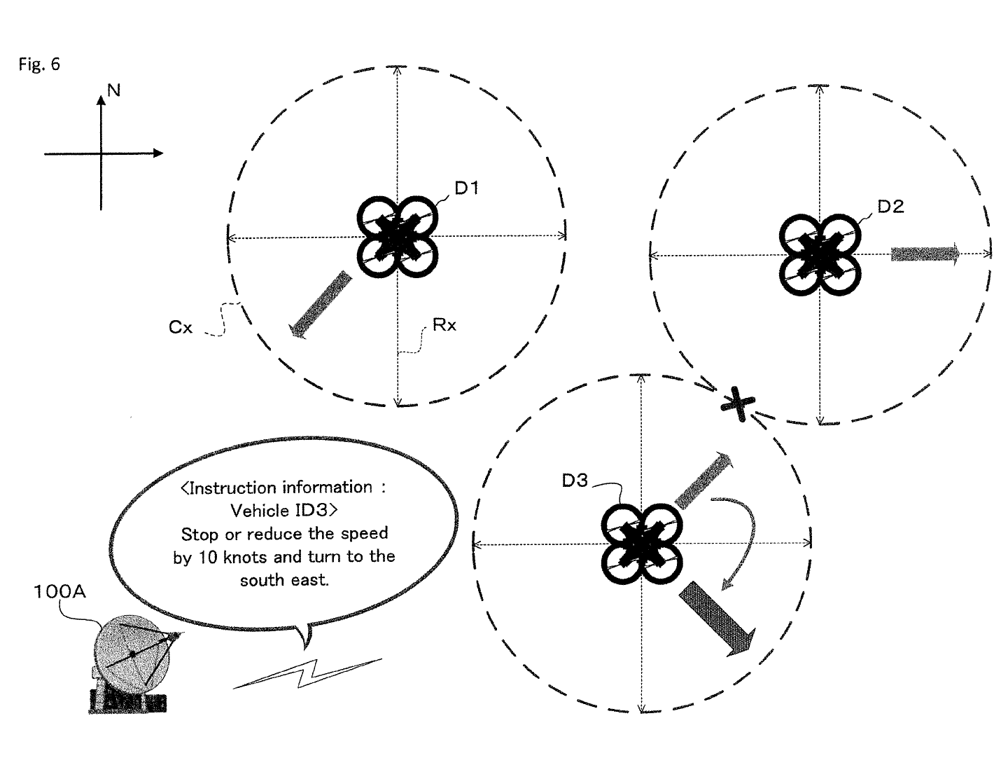

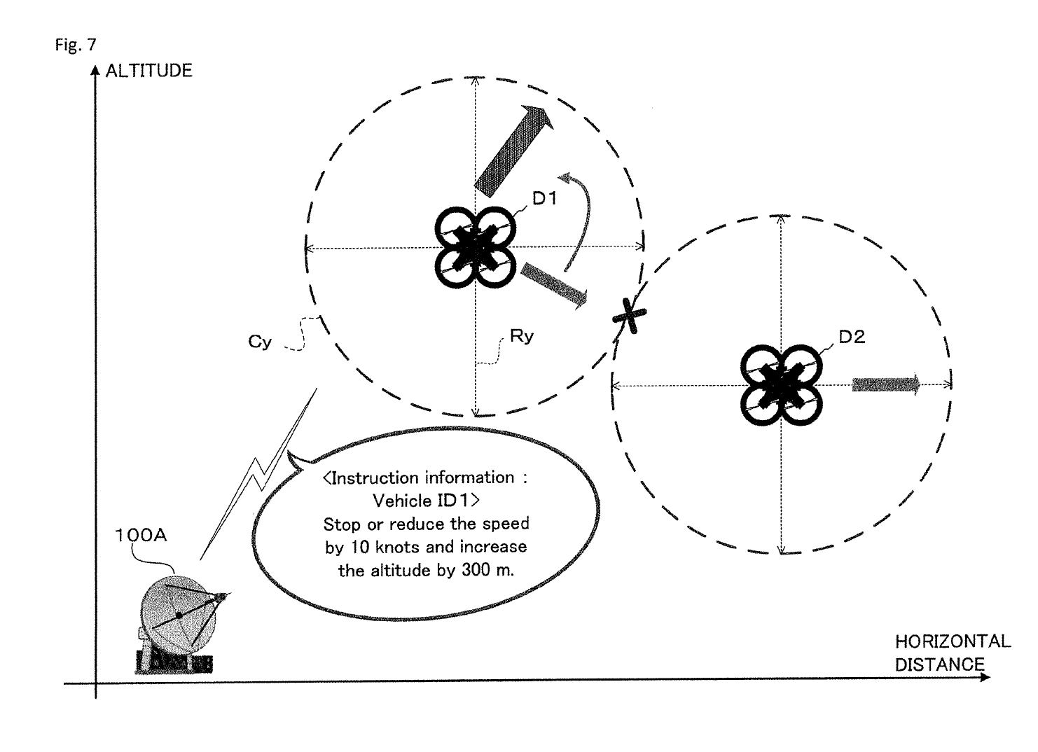

FIGS. 6 and 7 show one example of the action instruction by the distance instruction unit 160.

In the top view of a flight area seen from a predetermined altitude that is shown in FIG. 6, the three uninhabited vehicles D1, D2, and D3 are flying southwest, east, and northeast, respectively.

The distance instruction unit 160 acquires the latitudes, the longitudes, and the flight directions of the uninhabited vehicles D1 to D3 based on the location information transmitted from the uninhabited vehicles D1 to D3 and a time series of transition of the location information. Then, for example, the distance instruction unit 160 checks whether or not the distance intervals for the uninhabited vehicles D1 to D3 contact or overlap with each other. The distance intervals are the areas Cx that are circular in the horizontal direction or spherical and have the radius Rx set as a predetermined distance. In the example shown in FIG. 6, the third uninhabited vehicle D3 is flying toward the second uninhabited vehicle D2 faster than it. Thus, the distance intervals predetermined for the third uninhabited vehicle D3 and the second uninhabited vehicle D2 contact with each other. In this case, the distance instruction unit 160 transmits an instruction to the third uninhabited vehicle D3 and the information terminal that the user owns to maintain the distance intervals more than a predetermined value. For example, the instruction is to instruct the third uninhabited vehicle D3 to stop or reduce its speed and to change its course by flying away from the second uninhabited vehicle D2. Accordingly, the third uninhabited vehicle D3 or its user corrects the flight plan, so that the distance intervals for the third uninhabited vehicle D3 and the second uninhabited vehicle D2 are maintained. If the third uninhabited vehicle D3 does not follow the instruction, the distance instruction unit 160 may request the above-mentioned warning unit 140 to warn the third uninhabited vehicle D3 and also to prompt the third uninhabited vehicle D3 to force to stop.

Furthermore, as the relationship between the horizontal distance and the altitude of a flight area seen in the horizontal direction is shown in FIG. 7, the uninhabited vehicles D1 and D2 are flying at a predetermined speed in the same traveling direction. In addition, the second uninhabited vehicle D2 is flying, maintaining a constant altitude, and the first uninhabited vehicle D1 is flying higher than the second uninhabited vehicle D2. If the second uninhabited vehicle D2 descends and then approaches the first uninhabited vehicle D1, the areas Cy that are circular or spherical and have the set radius Ry for the uninhabited vehicles D1 and D2 contact or overlap with each other.

In this case, the distance instruction unit 160 transmits an instruction to the first uninhabited vehicle D1 and the information terminal that the user owns to maintain the distance intervals. For example, the instruction is to instruct the first uninhabited vehicle D1 to reduce its speed, ascend, retreat, or stop. Accordingly, the first uninhabited vehicle D1 or its user corrects the flight plan, so that the distance intervals for the first uninhabited vehicle D1 and the second uninhabited vehicle D2 are maintained in addition to their flight altitudes. If the first uninhabited vehicle D1 does not follow the instruction, the distance instruction unit 160 may request the above-mentioned warning unit 140 to warn the first uninhabited vehicle D1 and also to prompt the first uninhabited vehicle D1 to force to stop.

### Changing Plan Based on External Factor

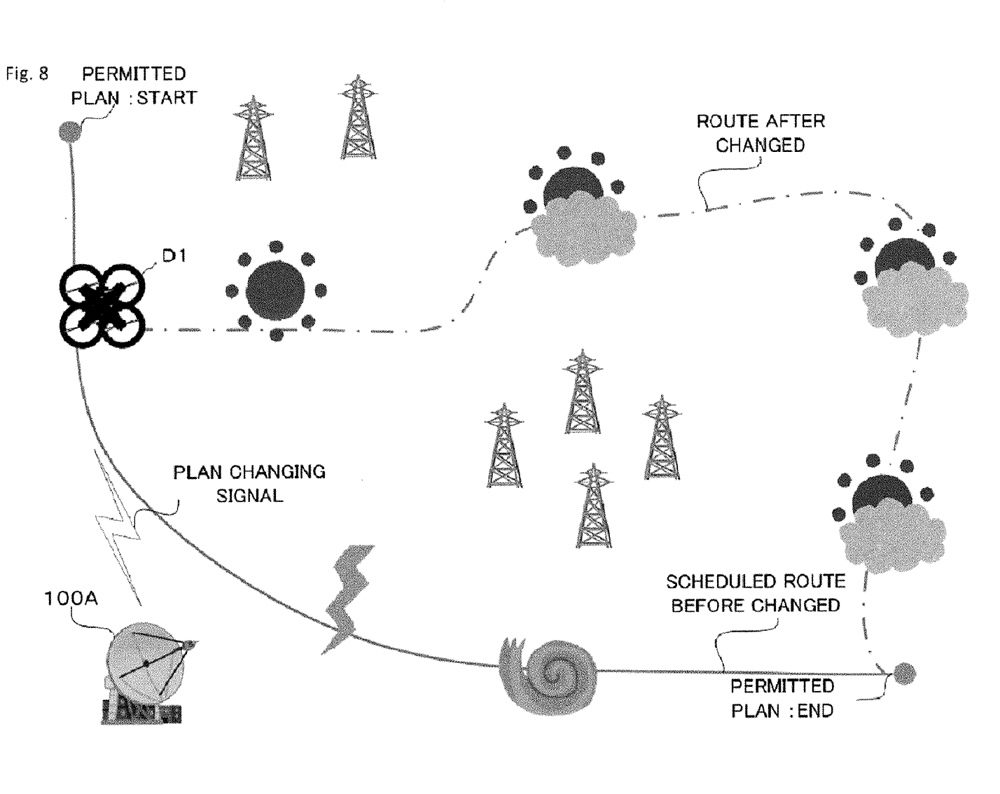

As shown in FIG. 8, a predetermined “scheduled route before changed” was previously applied and has been permitted as the flight plan of the uninhabited vehicle D1. The weather, which is an external factor affecting the uninhabited vehicle D1 that is to fly along “scheduled route before changed,” is assumed to have been changed because the weather event such as air turbulence, thunder, or downpour occurred in the scheduled route before changed. This weather event is acquired regularly by the above-mentioned weather information acquisition unit 171 and provided to the above-mentioned plan change unit 172.

The plan change unit 172 searches a route in a more stable weather condition that does not contain any no-fly zones for the occurrence of air turbulence, thunder, or downpour. When “route after changed” shown in FIG. 8 is searched, the latest plan transmission unit 173 transmits information that indicates the searched “route after changed,” to the uninhabited vehicle D1 and the information terminal that the user owns. Accordingly, the flight route of the uninhabited vehicle D1 is changed from “scheduled route before changed” to “route after changed” along which the external factor is more stable. Thus, the uninhabited vehicle D1 is capable to fly along an appropriate route with a relatively little influence to the flight even if the external factor such as a weather event changes.

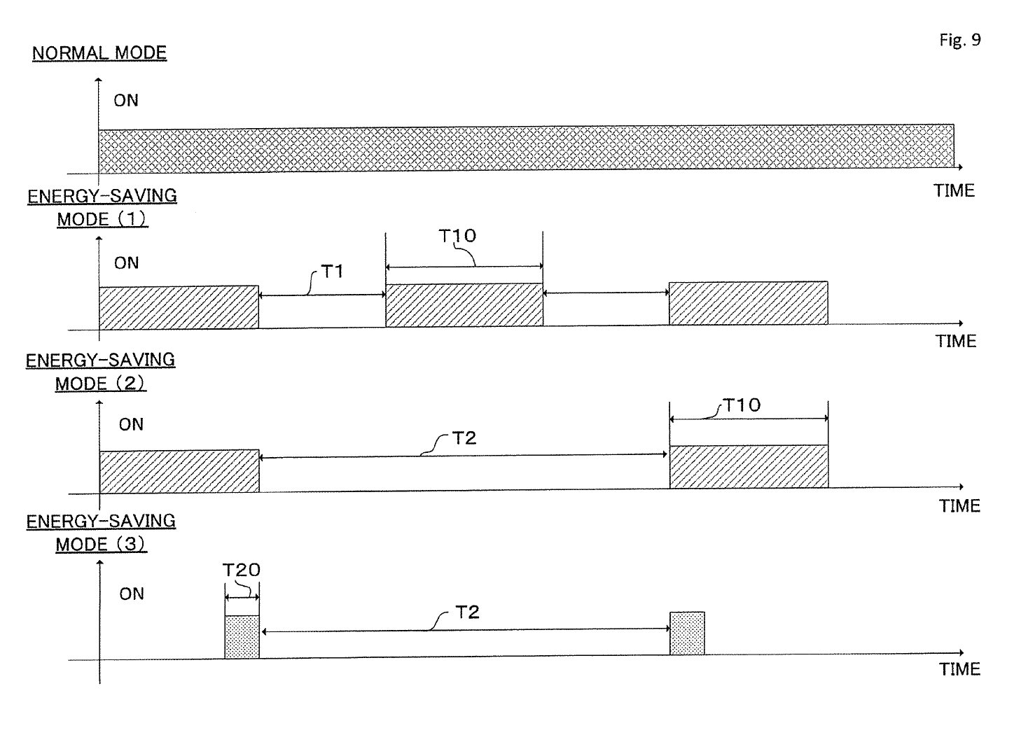

Transmitting and receiving location information and vehicle information FIG. 9 shows one example of the intervals of transmitting and receiving the location information and the vehicle information according to this embodiment.

As shown in FIG. 9, the location information receiving unit 111 and the vehicle information receiving unit 112 of the system for controlling traffic of an uninhabited vehicle 100A according to this embodiment have a plurality of operation modes such as “normal mode,” “energy-saving mode (1),” “energy-saving mode (2),” and “energy-saving mode (3).”

In “normal mode”, the location information receiving unit 111 and the vehicle information receiving unit 112 are always on so that they can receive the location information and the vehicle information. On the other hand, in “energy-saving mode (1)”, “energy-saving mode (2)”, and “energy-saving mode (3)”, the location information receiving unit 111 and the vehicle information receiving unit 112 start on the cycles T1, T2(>T1), and T2, respectively, to reduce the communication energy. The periods when the location information receiving unit 111 and the vehicle information receiving unit 112 are on T10, T10, and T20 (<T10), respectively. Accordingly, the location information receiving unit 111 and the vehicle information receiving unit 112 can receive the location information and the vehicle information only during the respective periods, so that the communication energy can be reduced.

In the same way, the uninhabited vehicles D1 to D3 may have “normal mode,” “energy-saving mode (1),” “energy-saving mode (2)”, and “energy-saving mode (3)”. These modes may be selected according to the battery charge remaining.

### Identifying Images

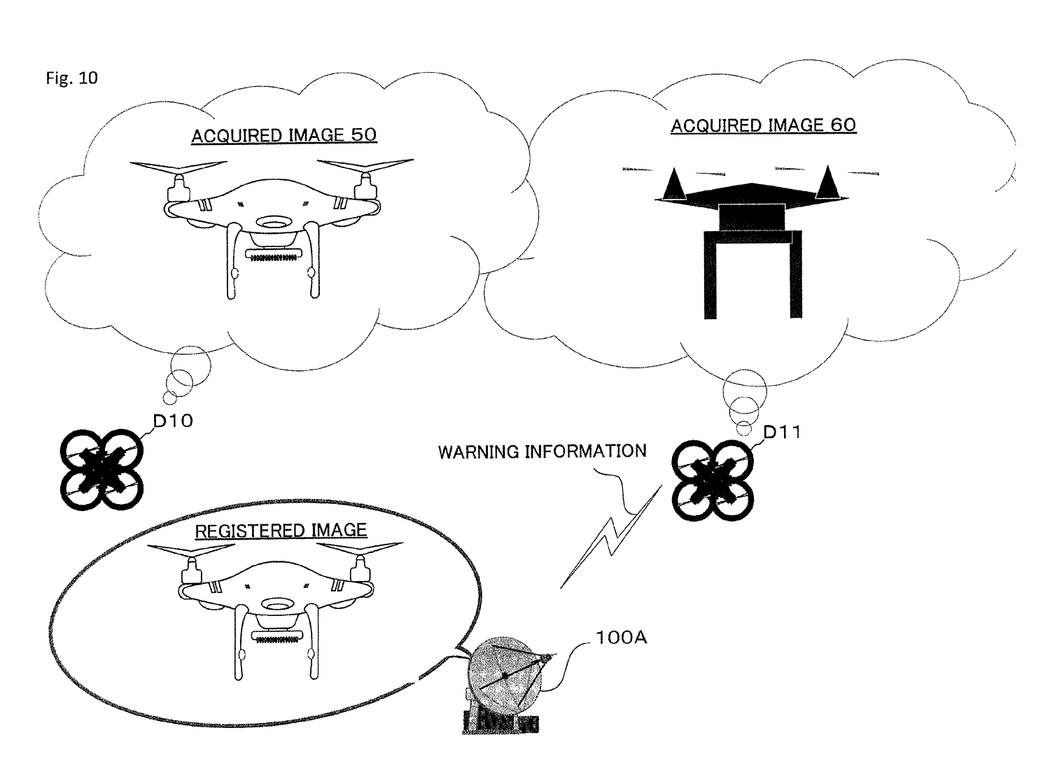

FIG. 10 shows one example of acquiring images by the above-mentioned image acquisition unit 180 and warning by the warning unit 140.

As shown in FIG. 10, the image acquisition unit 180 acquires images of the first uninhabited vehicle D10 and the second uninhabited vehicle D11 that are flying in the control area of the system for controlling traffic of an uninhabited vehicle 100A, through a network camera. The image acquisition unit 180 outputs the acquired image data to the above-mentioned plan check unit 120.

When the image data is input, the plan check unit 120 compares the feature amount of the image data with that of the image data that was acquired from the uninhabited vehicle with flight permission. For example, if the feature amount of the image data acquired from the second uninhabited vehicle D11 is not equal to that of any of the uninhabited vehicles with flight permission, the plan check unit 120 judges that the second uninhabited vehicle D11 are flying in the area where the flight is permitted. Then, the plan check unit 120 outputs the judgment result to the plan instruction unit 130 or the warning unit 140. Accordingly, the plan instruction unit 130 instructs the second uninhabited vehicle D11 to change the flight area, or the warning unit 140 warns the second uninhabited vehicle D11. This enables the plan check unit 120 to check compliance with the flight route based on the appearance even if it cannot acquire the vehicle information or the location information from the uninhabited vehicles D10 and D11.

### Controlling Traffic of Uninhabited Vehicle

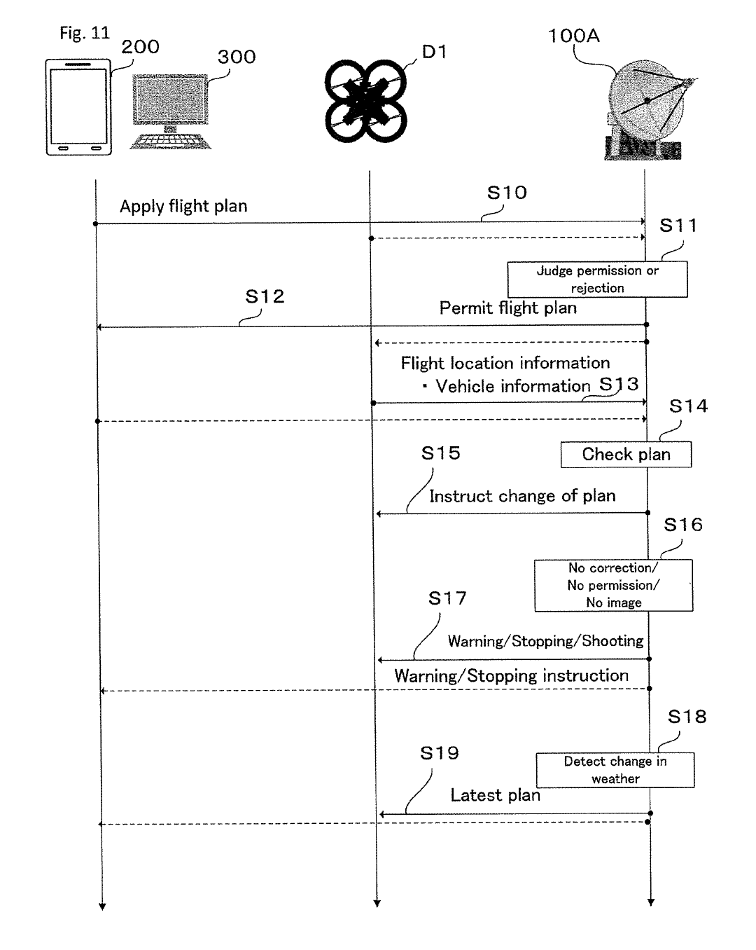

FIG. 11 shows the operation of a system for controlling traffic of an uninhabited vehicle 100A and a method, and a program for controlling traffic of an uninhabited vehicle according to this embodiment collectively.

First, when the flight plan is applied from the uninhabited vehicle D1 or the user's information terminal 200, 300 (S10), the system for controlling traffic of an uninhabited vehicle 100A checks, for example, whether or not the flight plan is contained in no-fly zones and whether or not the flight plan in which an overlapping flight date and time, route, and the like already exist (S11). Then, if the applied flight plan is not contained in no-fly zones and if the flight plan in which an overlapping flight date and time, route, and the like do not exist, the system for controlling traffic of an uninhabited vehicle 100A notifies the permission of the applied flight plan to the uninhabited vehicle D1 or the user's information terminal 200,300 (S12).

The uninhabited vehicle D1 or the user's information terminal 200,300 transmits the location information and the vehicle information to the system for controlling traffic of an uninhabited vehicle 100A at predetermined intervals after starting to fly (S13). The system for controlling traffic of an uninhabited vehicle 100A checks whether or not the location information and the vehicle information meet the permitted flight plan whenever receiving the information (S14). If judging that the location information and the vehicle information do not meet the permitted flight plan, the system for controlling traffic of an uninhabited vehicle 100A instructs the uninhabited vehicle D1 or the user's information terminal 200, 300 to follow the permitted flight plan (S15). If the uninhabited vehicle D1 does not correct the flight plan even after the instruction, the system for controlling traffic of an uninhabited vehicle 100A, warns the uninhabited vehicle D1 or the user's information terminal 200, 300 (S16, S17). The system for controlling traffic of an uninhabited vehicle 100A may check compliance with the flight plan of the uninhabited vehicle D1 based on the image of the uninhabited vehicle D1 or its acquisition position instead of the location information and the vehicle information.

Furthermore, when detecting the occurrence of rapid changes in the weather, air turbulence, lightning, and downpour in the flight plan of the uninhabited vehicle D1 (S18), the system for controlling traffic of an uninhabited vehicle 100A searches the route in a more stable weather condition again and prompts diversion to the scheduled place of arrival of the uninhabited vehicle D1 (S19).

The system for controlling traffic of an uninhabited vehicle 100A controls the flight of the uninhabited vehicle D1 and a plurality of other uninhabited vehicles through such processing as needed. Thus, the flight of the uninhabited vehicle is controlled appropriately.

The embodiments of the present invention are described above. However, the present invention is not limited to the above-mentioned embodiments. The effect described in the embodiments of the present invention is only the most preferable effect produced from the present invention. The effects of the present invention are not limited to that described in the embodiments of the present invention.

### REFERENCE SIGNS LIST

100, 100A system for controlling traffic of uninhabited vehicle

110 communication module

111 location information receiving unit

112 vehicle information receiving unit

120 plan check unit

130 plan instruction unit

140 warning unit

141 user warning unit

142 uninhabited vehicle control unit

143 uninhabited vehicle shooting unit

150 in-advance application receiving unit

151 permission transmission unit

160 distance instruction unit

170 external factor handling unit

171 weather information acquisition unit

172 plan change unit

173 latest plan transmission unit

180 image acquisition unit

200,300 information terminal

1. A system for controlling traffic of an uninhabited vehicle that is in action, comprising:
a location information receiving unit that receives location information from the uninhabited vehicle that is in action;
a vehicle information receiving unit that receives vehicle information from the uninhabited vehicle that is in action;
a check unit that checks whether or not the received location information and the received vehicle information are the same as those in the permitted plan;
a plan instruction unit that instructs the uninhabited vehicle to act in accordance with the plan if the check result is false;
an image acquisition unit that acquires an image from a network camera; and
a warning unit that issues a warning if the uninhabited vehicle that appears in the acquired image is not previously permitted.

2. The system according to claim 1, further comprising a user warning unit that warns a user of the uninhabited vehicle if the received vehicle information does not exist in the plan.

3. The system according to claim 1, further comprising an uninhabited vehicle control unit that forces the uninhabited vehicle to stop if the received vehicle information does not exist in the plan.

4. The system according to claim 1, further comprising an uninhabited vehicle shooting unit that shoots the uninhabited vehicle if the received vehicle information does not exist in the plan.

5. The system according to claim 1, further comprising:
an in-advance application receiving unit that receives in-advance application of the plan from a user of the uninhabited vehicle; and
a permission transmission unit that transmits permission for the received plan to the user.

6. The system according to claim 1, further comprising a distance instruction unit that instructs the uninhabited vehicle to keep a predetermined distance from a different uninhabited vehicle when the distance between the uninhabited vehicle and the different uninhabited vehicle fulfills a predetermined condition.

7. The system according to claim 1, further comprising:
a weather information acquisition unit that acquires weather information;
a change unit that changes the plan to a latest plan based on the acquired weather information; and
a latest plan transmission unit that transmits the latest plan to the uninhabited vehicle.

8. The system according to claim 1, wherein the location information receiving unit that receives location information from the uninhabited vehicle that is in action at a predetermined interval.

9. The system according to claim 1, wherein the vehicle information receiving unit that receives the vehicle information from the uninhabited vehicle that is in action at a predetermined interval.

10. (canceled)

11. A method for controlling traffic of an uninhabited vehicle that is in action, comprising:
receiving location information from the uninhabited vehicle that is in action;
receiving vehicle information from the uninhabited vehicle that is in action;
checking whether or not the received location information and the received vehicle information are the same as those in the previously permitted plan;
instructing the uninhabited vehicle to act in accordance with the plan if the check result is false;
acquiring an image from a network camera; and
issuing a warning if the uninhabited vehicle that appears in the acquired image is not previously permitted.

12. A computer program product for use in a system for controlling traffic of an uninhabited vehicle that is in action, comprising a non-transitory computer usable medium having a set of instructions physically embodied therein, the set of instructions including computer readable program code, which when executed by the system causes the information processing unit to:
receive location information from the uninhabited vehicle that is in action;
receive vehicle information from the uninhabited vehicle that is in action;
check whether or not the received location information and the received vehicle information are the same as those in the previously permitted plan;
instruct the uninhabited vehicle to act in accordance with the plan if the check result is false;
acquire an image from a network camera; and
issue a warning if the uninhabited vehicle that appears in the acquired image is not previously permitted.
